(19) United States
(12) Patent Application Publication
(10) Pub. No.: US 2008/0079581 A1
(43) Pub. Date: Apr. 3, 2008

(54) Lost item notification and recovery system

(76) Inventor: Tom Price, Marietta, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 11/542,447

(22) Filed: Oct. 3, 2006

(51) Int. Cl. G08B 13/14; G08B 1/00; G06F 17/00

(52) U.S. Cl. 340/572.1; 340/531; 235/375; 340/568.1

(57) ABSTRACT

A largely or totally automated lost item notification and recovery system that avoids language barriers by providing a short description of the item entered by the subscriber and stored in a database in any lost item notification message communicated to the subscriber concerning the item. The lost item notification message may also include an indication of the language used by the reporting party when placing the lost item report, and may also include an indication of the geographic location where the lost item report originated. The system may also activate pre-defined countermeasures associated with the lost item once the item has been reported lost and implement a reward system providing compensation to the reporting party or others upon successful return of the lost item.

### TECHNICAL FIELD

The present invention is generally related to lost-and-found systems and, more particularly, to a lost item notification and recovery system configured to overcome human communication and language barriers during the lost item recovery process and implement countermeasures in connection with lost items and to drastically speed up the recovery process for the owner of a lost item.

### BACKGROUND OF THE INVENTION

Over the years, numerous attempts have been made at developing cost effective lost-and-found systems for personal items, such as a cell phones, keys, luggage, etc. In general, a subscriber registers with a lost-and-found service, which assigns the subscriber a personal ID number (PIN) and records that person's contact information so that he or she can be contacted when a lost item has been recovered. The lost lost-and-found systems then issues the subscriber a number of item registration numbers, usually in the form of ID tags to be placed on the subscriber's items. Each item registration tag displays an associated item registration number and a toll-free telephone number that the finder can call to initiate the return process. The lost-and-found system maintains a database of its subscribers, their associated item registration numbers (tag numbers), and contact information. Then when a lost item is recovered, the finding party calls the toll-free number displayed on the tag and provides the tag ID number to the lost-and-found system. Certain lost-and-found systems have relied on human operators, while others have used automated voice response systems.

The basic subscriber and items registration system described above is fairly standard insofar as a database of item registration numbers, subscriber PINs and contact information are typically used whenever operating any lost and found system. However, there are a number of practical problems that arise when implementing a large-scale lost-and-found system that have not been adequately resolved in any prior system. A first challenge concerns subscriber contact information and item registration. The operator of the lost and found system must create and maintain a sufficiently large lost-and-found database to support a significant business enterprise. In generally, prior systems require a human operator to create the database on a subscriber-by-subscriber basis, which is costly and time consuming. Prior system have also failed to provide sufficiently sophisticated database functionality suitable for subscribers who have multiple users, such as employees and family members, with multiple communication modes and that can change over time.

A second challenge concerns lost item reporting communication, which includes the procedures for communicating with the finders of the lost items. Most lost-and-found systems rely on a human-operated call center to process the incoming telephone call from persons who have found lost items. Although this approach provides a high degree of flexibility and intelligence in the call handling process, it is very expensive because it relies on human operators who require at least a moderate level of training and support. Although some prior lost and found systems have utilized voice response units to automatically interface with the finding parties, these systems have not considered many of the practical challenges of a large-scale system. In particular, prior systems have not addressed important issues such as language compatibility and the need to minimize the length and complexity of the lost item reporting communication, so that the finding party does not become confused or frustrated and hang up before completing an effective lost item report.

A third challenge concerns lost item notification communication and return process, which includes the procedures for notifying the subscriber that a lost item has been reported and facilitating the return of the lost item. Most lost-and-found systems require that the finding party to leave a message for the owner of the lost item presume that owner and the finder of the lost item speak the same language and will be able to communicate adequately to make arrangement for return of the lost item. This may not be a valid assumption, particularly for items that may become lost when the owner is traveling abroad. In addition, most lost-and-found systems require that the found items be returned to a central location operated by the lost and found system, which uses a human operator to notify the subscriber and ship the found item back to the owner. This process is time consuming and expensive, requiring a fee in the range of ten to twenty dollars for each returned item. Obviously, this limits the feasibility of this type of lost-and-found system to relatively expensive items. Incurring this level of cost in order to recover a lost item also inhibits subscribers from using a large number of item tags, since they have to be prepared to pay for the return of any item that may be reported. These factors are major impediments to the deployment of a large scale lost-and-found system suitable for both expensive and for relatively low-cost items. As a result, there is a continuing need for an improved need for an improved lost item notification and recovery system.

### SUMMARY OF THE INVENTION

The present invention meets the needs described above in a lost item notification and recovery (LINR) system that includes a number of improvements over prior lost-and-found systems. These advantages are found in the set-up or provisioning stage of the system, the subscriber contact information and item registration process, the creation and ordering of lost item management tags, the lost item notification process, countermeasures that may be implemented once an item has been reported lost, and in a reward system that may be used to compensate the reporting parties and others, possibly including the LINR system operator, for successfully effecting the return the lost items to the rightful owners. In general, the system is designed to minimize the need for human involvement by employees of the LINR system in the administration of the system, while implementing flexibility and robustness in system operation that has not been previously available in any lost-and-found system. All the above can be accomplished while providing the owner of a lost item notification within seconds of being reported found and providing a mechanism whereby the finder and owner can arrange a meeting to recover the lost item.

The LINR system is also designed to avoid language barriers that may exist between the owner of the lost item or another authorized person using the LINR system (generally referred to as the “subscriber”) and the party who may find a registered item after it becomes lost (generally referred to as the “reporting party”) to facilitate the recovery of lost items when the subscriber is traveling abroad. In particular, the subscriber enters a short description of the item into a database record for the item when registering the item for the LINR service. If the item becomes lost, this description is used to identify the lost item to the owner in the lost item notification message, so that the owner can easily ascertain the identity of the item without having to rely on the reporting party's description or resort to a look-up table. This allows the subscriber to identify the item with particularity, so that he or she can determine whether recovery of the particular item is worthwhile. In addition, the lost item notification message apprises the subscriber of the language used by the reporting party during the lost item reporting communication. This allows the subscriber to have an appropriate interpreter available, if necessary, to correspond with the finding party. The lost item notification message may also identify the geographic location of origin of the lost item reporting communication, which the owner can use to validate and screen lost item notification messages.

Generally described, a subscriber of the LINR system registers an item for lost item management by accessing the LINR system and entering a brief description of the item and contact information associated with the item. The LINR system then assigns an item registration number to the item and stores the brief description of the item, the contact information associated with the item, and the item registration number in a computer file. The item selected for lost item management is then tagged by rendering a tag displaying a lost item message, reporting information, and the item registration number and affixing the tag to the item. The LINR system then facilitates return of the item when it becomes lost by receiving a lost item report from a reporting party in accordance with the reporting information contained on the tag indicating that the item has become lost. The LINR system also ascertains the return communication information associated with the reporting party, retrieves the brief description of an item from the computer file, and delivers a lost item notification message in accordance with the contact information contained in the computer file.

To ensure that the subscriber understands the identification of the item that has been reported lost, the lost item notification message includes the return contact information associated with the reporting party as wells as the brief description of the item retrieved from the computer file. It should be appreciated that this description of the item was entered into the LINR system by the subscriber at the time that the subscriber registered the item with the LINR system. By using this description of the item, rather than a description obtained from the reporting party, the subscriber does not have to rely on the reporting party to identify the lost item. This avoids what could otherwise be a cumbersome reporting process that could often result in an inaccurate or confusing identification of the lost item, particularly when the reporting party does not speak the same language as the subscriber.

To further assist the subscriber, the LINR system may receive caller identification information (CLID) associated with the lost item report indicating an originating directory number assigned to a communications device used to originate the lost item report and include the originating directory number in the lost item notification message provided the subscriber. The LINR system may also prompt the reporting party to record a voice message with return contact information, record the voice message, and play the voice message (which the LINR system may translate, if appropriate) in connection with the lost item notification message. The LINR system may also ascertain that the lost item has been returned and provide a reward to the reporting party, such as a free subscription to the LINR system or some other type of inducement. Advantageously, the LINR system may be configured to automatically implement the procedures described above, including most notably registering an item for lost item management and facilitating return of the item upon becoming lost, without intervention by a human operator.

According to another aspect of the invention, the LINR system may ascertain a reporting language used by the reporting party when communicating the lost item report, and include an indication of the reporting language and the return communication information associated with the reporting party. This allows the subscriber to obtain the assistance of a person speaking the same language as the reporting party, if necessary, before contacting the reporting party to arrange recovery of the lost item. This is a particularly useful feature for persons who might lose an item while traveling abroad, for example on vacation or a business trip.

In another feature of the invention, the LINR system ascertains reporting location information from communication routing information associated with the lost item report and delivers the reporting location information and the return communication information associated with the reporting party. For example, the reporting location information may include a relatively course location of the originating telephone through an identification of an originating cellular tower, base station, telecommunications switch, or inter-exchange switch associated with the lost item report. As another more accurate approach for fixing the location of the originating telephone unit, the cellular system may triangulate to locate the originating telephone unit, or the telephone unit itself may provide a GPS signal indicating its location. Whatever the source or accuracy of the location fix, this information may useful to the subscriber to validate the authenticity on the lost item report and possibly to facilitate the recovery of the item. the or other location of the telephone used to originate the lost item report

As another feature of the invention, the item registered for lost item management may be equipped with a countermeasure device having a countermeasures address, and the LINR system may send a countermeasures activation message to the countermeasures address in response to receiving the lost item report. The countermeasures activation message activates a countermeasure affecting the lost item. For added security, the LINR system may require a communication from the subscriber including a countermeasures password as a condition to sending the countermeasures activation message. Examples of countermeasures include an electronic lock carried by the item disabling operation of the lost item, a tracking device carried by the item configured to transmits a location identifying signal from the item, an alarm carried by the item, and an RFID device associated with the tag attached to the item. Of course, other countermeasures could be implemented, as appropriate for a particular item.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

FIG. 1 is a functional block diagram of a lost item notification (LINR) system.

FIG. 2 is a conceptual illustration of an item registration tag.

FIG. 3 is a conceptual illustration of an item registration number.

FIG. 4 is a functional block diagram of an item configured to implement countermeasures upon receiving a lost item countermeasures activation communication message from a lost item management (LIM) system.

FIG. 5 is a functional block diagram of lost item reporting and lost item notification communications in the LINR system.

FIG. 6 is a logic flow diagram illustrating a process for implementing an automated LIM system.

FIG. 7 is a logic flow diagram illustrating a process for provisioning an automated LIM system.

FIG. 8 is a conceptual diagram of a customer and group registration panel for the LIM system.

FIG. 9 is a conceptual diagram of a contact profile entry panel for the LIM system.

FIG. 10 is a conceptual diagram of an item registration profile entry panel for the LIM system.

FIG. 11 is a logic flow diagram illustrating a lost item management process.

FIG. 12 is a logic flow diagram illustrating an item registration process.

FIG. 13 is a logic flow diagram illustrating a process for facilitating lost item recovery.

FIG. 14 is a logic flow diagram illustrating a lost item notification process.

### DETAILED DESCRIPTION OF THE EXEMPLARY EMBODIMENTS

The present invention may be embodied in a largely or totally automated lost item notification and recovery (LINR) system that avoids language barriers by providing a short description of the item entered by the subscriber and stored in a database in any lost item notification message communicated to the subscriber concerning the item. The lost item notification message may also include an indication of the language used by the reporting party when placing the lost item report, and may also include an indication of the geographic location where the lost item report originated. The LINR system may also activate pre-defined countermeasures associated with the lost item once the item has been reported lost and implement a reward system providing compensation to the reporting party or others upon successful return of the lost item.

The methodology of the LINR system may be implemented in a number of different ways, including an operated-assisted system, a fully automated system, or a combination of the two. In general, it is cost effective and desirable to implement as much of the LINR system as possible in a largely or totally automated, operator-free Lost Item Management (LIM) system. The following description will, therefore, focus mainly on the automated aspects of the LIM system, which may be augmented by a human operator on an as-needed basis. It should be understood, however, that an operated-assisted system could be used to augment the automated functionality described for the LIM system. In addition, the person interacting with the LIM system to register items for lost item management will be referred to as the “subscriber,” “customer” or “user” and the person finding and reporting a lost item will be referred to as the “finder” or “reporting party” as if a single individual is involved in each instance. Nevertheless, it should also be understood that the LIM system is intended to implemented by families, businesses, governmental organizations, social associations and other groups in which each subscriber may represent a small or large number of individuals that may each have an associated groups of registered items, which may potentially be subdivided into sub-groups for administrative purposes. Of course, the same person need not take each and every step associated with a subscriber, and in fact the LIM system may be used most effectively where a particular authorized person, such as a parent or project administrator, handles item registration, while the individuals issued the items may implement the steps associated with lost item recovery. Similarly, the same person need not take each and every step associated with the reporting party.

At the provisioning stage, the LIM system includes a menu-driven subscriber interface that facilitates the creation of a database populated with information entered by the subscribers without the assistance of personnel. This is an important aspect of the LIM system because it allows wide-scale deployment of the system without the limitations and expense associated account setup and data entry assistance by human operators. In practice, it is anticipated that the same basic subscriber interface will be translated into a number of foreign languages and used to support the creation of a large world-wide LIM system database with minimal involvement of the LIM system personnel other than initial system provisioning, occasional system maintenance and enhancement, and management of the hardware and communication infrastructure.

With respect to subscriber contact information and item registration, the subscriber interface allows each subscriber to define a customer profile establishing a hierarchical system of contact information, typically including a language of choice, one or more telephone numbers, and one or more email address. The subscriber may also define multiple contact profiles, whereby different items may be associated with different contact profiles created by the subscriber. For example, a corporate subscriber may establish a different contact profile for each employee, in which the hierarchical contact list for a particular employee includes contact numbers for the employee, the employee's administrative assistant, and a dedicated program management person. As another example, a parent subscriber may establish a different contact profile for each child, in which the hierarchical contact list for a particular child includes contact numbers for the child, a day-care center or school, and the parent. Each subscriber may then access the subscriber interface on an as-needed basis to add items, change contact information, redefine contact profiles, and so forth. Importantly, once the subscriber interface has been provisioned with appropriate user input panels, instructions and help resources, the subscribers themselves enter the data to register the individual items without the need for human assistance by LIM system personnel.

The LIM system also includes a robust lost item management tag ordering system that allows subscribers to create and order a variety of lost item management tag. Because the LIM system associates item registration numbers with individual subscribers, each item registration number must be unique and registered in the LIM database. As a result, the activity of entering the item into the LIM database, and associating a unique item registration number with each registered item, can be use as the tracking event for billing and administration purposes. For this reason, it is not necessary that the tags be issued or sold by the company. Although tags may be sold to generate revenue or as a convenience for the subscribers, there is no need to sell physical tags as part of a successful business model. In fact, item registration numbers can be freely distributed for use by product manufactures, retailers, employers and other organizations without charge. Therefore, the LIM system allows subscribers to order item registration numbers without charge, and they can, for example, print their own tags in whatever manner they wish. The may also download a tag image rendered by the LIM system using a “printer friendly” option to create the desired tags. Nevertheless, the LIM system can also sell tags of different descriptions as a service to its customers. For example, subscribers can order durable printed labels, self-adhesive plastic tags, metal tags, hang tags, embroidered labels for sewing into clothes, and so forth.

After the subscriber orders or otherwise obtains an item registration tag, the item registration number must be entered into the LIM system to activate the lost-and-found service for that particular item. This process is easy to use, menu-driven, and involves optional levels of sophistication. At a minimum, the subscriber associates the item registration number with a subscriber contact profile and enters a short description of the item. This is an important feature of the LIM system, because the item description entered by the subscriber at the time of registration (which can be updated at any time by the subscriber) will be provided back to the subscriber in the event that the item becomes lost, and the item registration number is received by the LIM system to initiate the lost item notification and recovery process. That is, the LIM system uses the subscriber's own description of the item to identify the lost item during the lost item notification and recovery process. This avoids any language barriers that might exist between the subscriber and the finding party, and also allows the subscriber to immediately know precisely which item was found so that he or she can immediately make an informed decision about whether to try to recover the item, and if so just how the urgent the situation may be.

Thus, the subscriber activates the LIM system by creating at least one subscriber contact profile in the LIM database, obtaining at least one item registration number, associating the item registration number with the subscriber profile and a short description of the item in the LINR database, obtaining a suitable LIM tag displaying the item registration number and the LIM toll-free telephone number, and affixing the LIM tag to the appropriate item. Should the item become lost, the finding and reporting party calls to the LIM toll-free telephone number, which connects them to an automated voice response unit (VRU) that handles the telephone call. The LIM system recognizes that the item may have been lost anywhere in the world, and is configured to assist subscribers in recovering lost items while traveling abroad. Specifically, the VRU determines the directory number of the originating telephone (caller ID, when available) and a geographic location of origin of the lost item telephone call. This allows the VRU to prompt the calling party to select a communication language from a short, prioritized list of options based on the geographic location of origin of the lost item report, as determined from characteristics or other information associated with telephone call used to place the lost item report. Once the calling party selects the language of choice, VRU prompts in the selected language to enter the item registration number displayed on the LIM tag.

In general, the geographic location of origin of the lost item telephone call is parameter that can be ascertained from the originating directory number and reference to a local number portability (LNP) database for a land-line unit, or a local or home location register for a mobile unit, indicating where the applicable telephone is registered for service. Alternatively or additionally, originating location information may be obtained by from the identification of the originating switch, originating cellular tower mobile, or a long-distance interchange switch transmitting the telephone call. For domestic US and Canadian telephone calls, this information can typically be ascertained from a call detail record (CDR) created to document the telephone call for billing purposes, or an in-process CDR interface operable for downloading that information from the applicable device as the CDR is created for billing purposes. For other international telephone calls, this information can be ascertained from the identification of the international gateway or long-distance interchange carrier transmitting the telephone call. Other sources of this information may be available, such as an SS7 or overhead data message provided by the carrier for this or a similar purpose, a database or interface provided as a signal control point (SCP), or other piece of equipment in the integrated telephone system.

If the directory number of the originating telephone (caller-ID or CLID) was successfully recovered (this information can be blocked), the VRU may have sufficient return contact information to implement the lost item recovery process. In this case, the VRU may play a short message thanking the calling party and explaining that the owner will be notified and given the caller-ID directory number to initiate the recovery process. Note that in this case, the calling party need not give a description of the item or enter any other contact information, which makes the system very quick and easy for the calling party. Although this process may work in many instances, it may be helpful and more polite for the VRU to play a message that explains that the caller-ID has been captured, to ask permission to use this number to contact the finding party, and to also give the finding party the option to enter additional contact information, preferably using the telephone keypad to avoid miscommunication. Of course, the calling party may also be given the option of leaving a voice message or, if necessary, talking to a human operator. Ultimately, the VRU completes the communication having obtained an indication of the geographic location of the origin of the lost item report, an indication of the language used by the reporting party, and at least one piece of return contact information that the subscriber can use to recover the lost item from the reporting party.

More specifically, the VRU is preferably configured to obtain the following information from the lost item reporting telephone call: (1) the item registration number, (2) the geographic location of origin of the lost item telephone call, (3) the language of communication selected by the finding party, (4) the originating directory number (caller ID, if available), (5) any additional contact information provided by the finding party, and (6) a voice message left by the reporting party, which the LIM system may translate if the subscriber and reporting party use different languages. Of course, additional information may be prompted and collection as the discretion of the VRU system implementer. For example, the finding party may be prompted to leave information such as his or her current location, how long they will be there, etc. This type of information may be used to support immediate recovery procedures implemented by the VRU. For example, the VRU will typically contact the subscriber immediately upon receipt of the lost item report an play back this to the subscriber so that the subscriber can possibly recover the lost item immediately. This is one of the important advantages of the LIM system, for example allowing a subscriber who leave an item, such as his or her credit card, in a restaurant and be notified within minutes of losing it or even before realizing that it was lost.

The VRU initiates the notification and recovery process by looking up the subscriber profile associated with the lost item registration number, and implementing the associated contact protocol. Importantly, when the subscriber receives the lost item notification message, it originates from the LIM system rather than the finding party, and it identifies the lost item using the subscriber's own brief description of the item entered at the time of registration. The lost item notification message also preferably indicates the location used by the reporting party, the location of origin of the lost item report, and a voice message left by the reporting party, which may be translated if appropriate. As noted previously, this avoids any language barriers that might exist between the subscriber and the finding party, and also allows the subscriber to immediately know precisely which item was found so that he or she can immediately make an informed decision about whether to try to recover the item.

If the lost item has been configured for countermeasures, upon receiving the lost item report, the subscriber may place a telephone call to the LIM system or access the LIM system over the Internet to initiate countermeasures as provisioned and configured by the LIM system. For example, the countermeasures may include devices carried by the item itself, such as an electronic lock, RFID chip, location tracking and reporting device, alarm, and the like. Countermeasures may also be implemented by third parties, such as deactivating a credit card or security access device. Once the lost item has been successfully returned, the LIM system, or for this feature a human operator, may implement a reward system to compensate the reporting party and possibly others, potentially including the LIM system operator, based in part on the value or importance of the returned item. For example, the reward may include a free subscription to the LIM system for inexpensive returned items, or a cash reward for expensive or important lost items, such as firearms and computers.

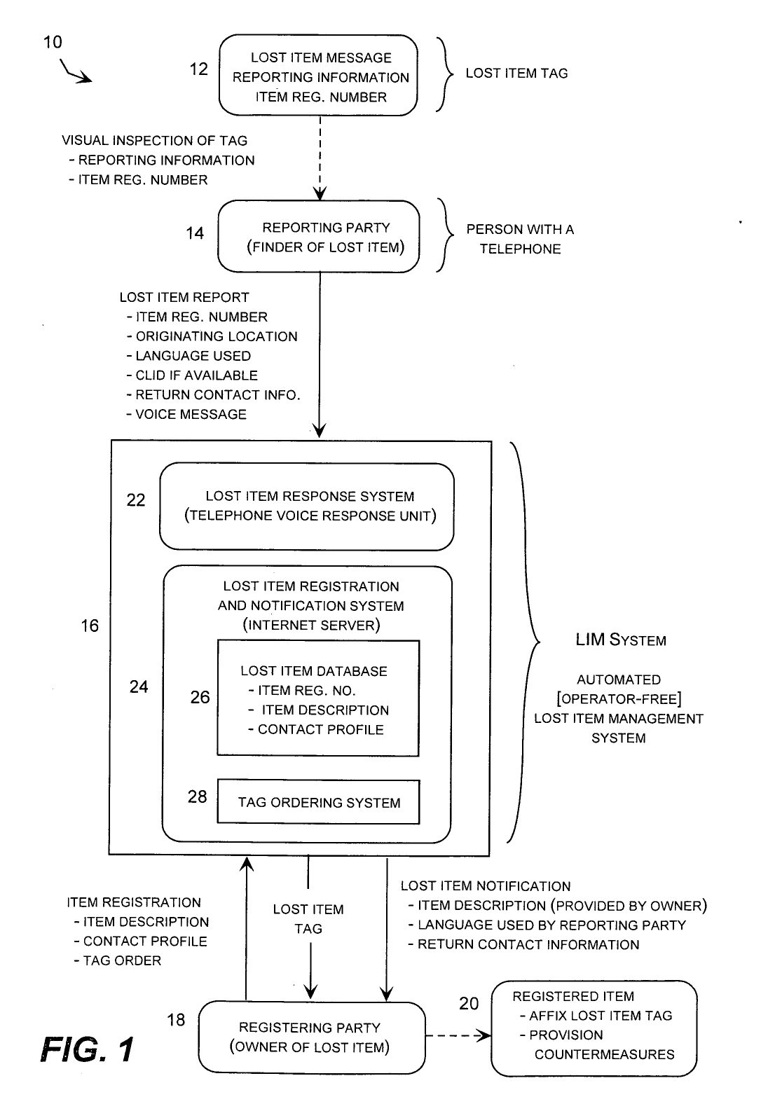

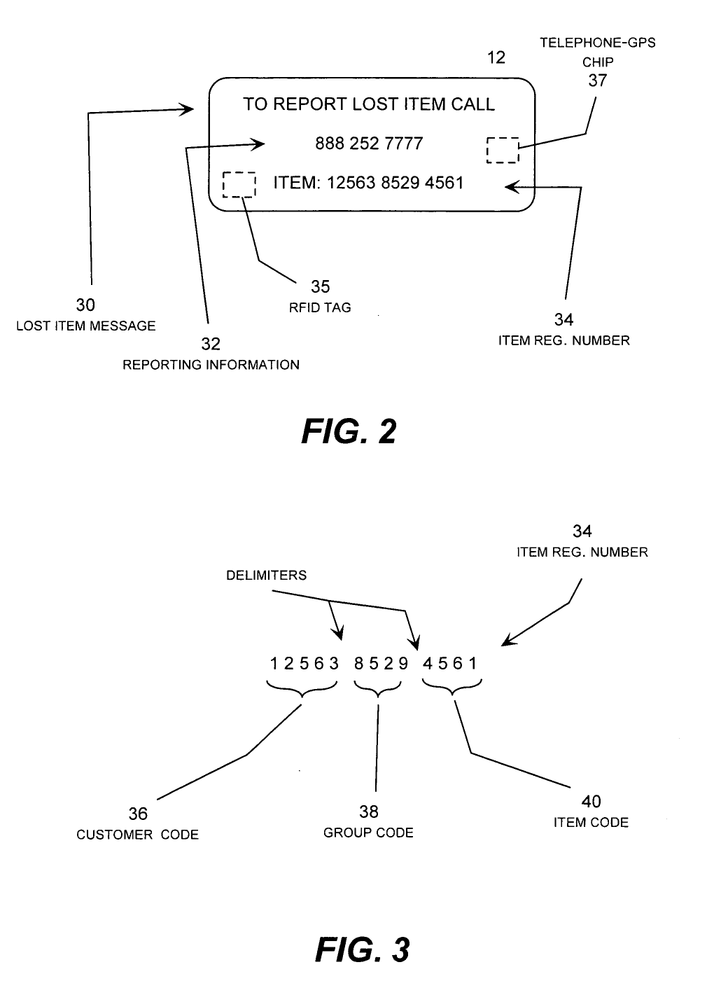

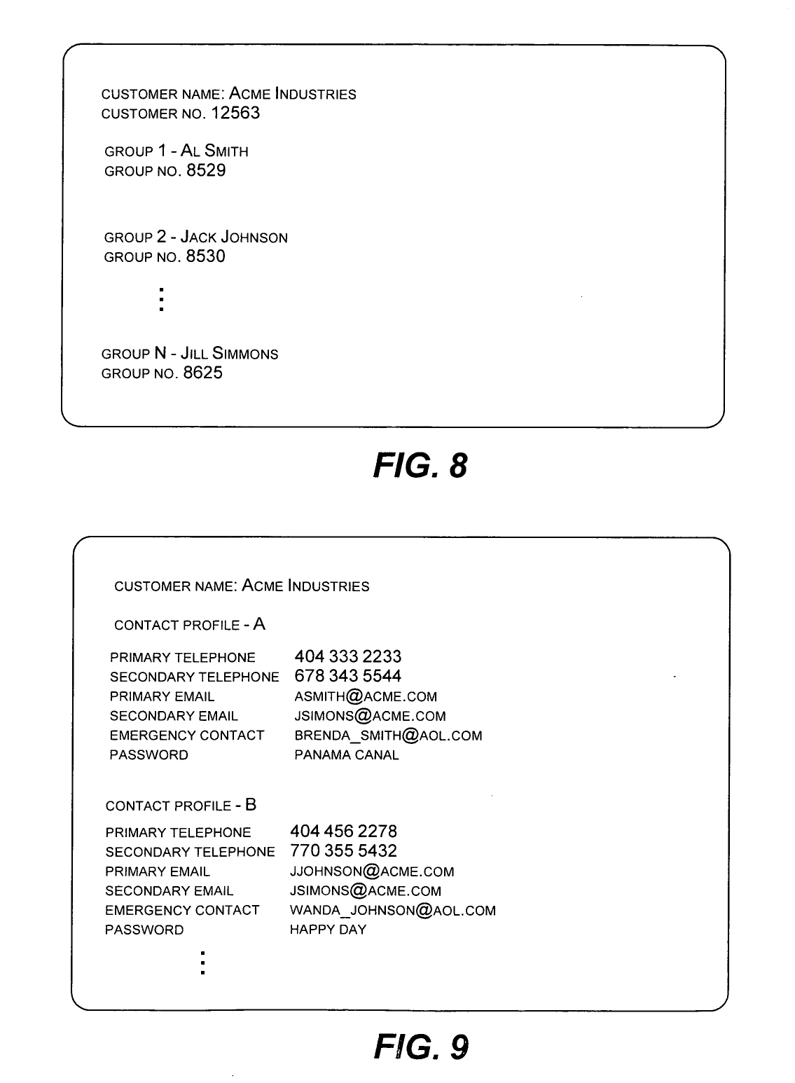

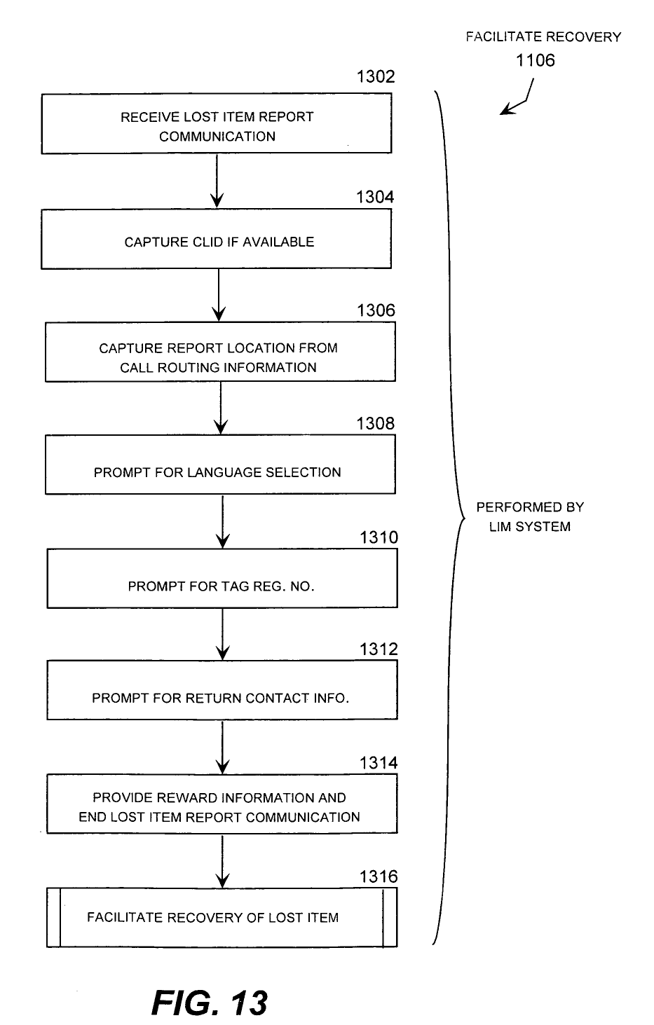

Turning now to the figures, in which like numerals refer to like elements throughout the figures, a specific embodiment of the invention will be described for illustrative purposes. FIG. 1 is a functional block diagram of the LINR system 10. The basic elements include a potentially very large number of lost item management tags, which are represented by the lost item management tag 12 shown in FIG. 1. At a minimum, the lost item management tag includes a lost item message, reporting information, and an item registration number. For example, as shown in FIG. 2, the lost item message may be “To Report Lost Item CALL”; the reporting information may be a toll-free, internationally available telephone number such as “888 252 7777”; and a suitable item registration number, such as “ITEM: 12563 8529 4561.” The purpose of the tag 12 is to facilitate a person who finds the lost item, referred to as the reporting party 14, to place a lost item report using the information displayed on the tag. In this example, the reporting party 14 places a telephone call to the toll-free telephone number displayed on the tag, which connects the reporting party with a Lost Item Management System (LIM system) 16. The LIM system is preferably an automated, multiple-language, operator-free platform that includes a lost item response system 22, that typically includes a programmable telephone Voice Response Unit (VRU). The VRU is a programmable telephone call handling system configured to handle incoming lost item reports, a particular example of which is described in detail with reference to FIG. 13. The LIM system also includes Lost Item Registration and Notification System 24, typically a database and computer-controlled device implementing associated functionality deployed on or including an Internet server for subscriber interaction. Specific examples of user interface panels for the Lost Item Registration and Notification System are shown in FIGS. 8-10.

Although the Lost Item Registration and Notification System 24 may include additional components, its basic elements include a Lost Item Database 26 and a Tag Ordering System 28. The Lost Item Database 26 is typically implemented as a structured database provisioned by the operator of the LIM system, and upgraded from time to time, in which each subscriber maintains his or her lost item registry. Similarly, the Tag Ordering System 28 is typically implemented as an automated service that assigns unique tag numbers and provided a number of options for ordering or printing different types of tags, at the subscriber's election. In most cases, the subscribers will be able to create their own lost item registries, and maintain those lost item registries over time, with little or no assistance from a live operator. The subscribers will also be able to select an appropriate type of tag on an item-by-item basis, and either print the tags locally or order the tags from a vendor, as desired, using the Tag Ordering System 28. In this manner, the LINS 16 will be able to support a large number of subscribers with a very large number of items registered for lost item management with a relatively low level of live support personnel.

FIG. 1 illustrates the overall operation of the LINR 10, which will be described for an illustrative subscriber, referred to as the registering party or subscriber 18, and an illustrative item 20 registered for lost item management. As a preliminary step, the operator or proprietor of the lost item management service provisions the LIM system 16, including the Lost Item Response System 22 and the Lost Item Registration and Notification System 24. Once the LIM system 16 is set up, the subscriber 18 accesses the Lost Item Registration and Notification System 24 to register a particular item 20 for lost item management. When registering the item 20 for lost item management, the subscriber 18 creates a LIM system record for the item in the Lost Item Database 26. As part of the registration process, the LIM system 16 assigns a unique item registration number to the item, which is subsequently used to uniquely identify the item in the lost item management process. This LIM system record for the particular item 20 includes the item registration number assigned to the item, which is typically the same number displayed on the associated tag 12, a brief description of the item entered by the subscriber 18, and a contact profile containing information for notifying certain parties in accordance with the contact profile in the event that a lost item report is received for the item. The subscriber 18 also prints or orders the associated tag 12 and affixes the tag to the item 20.

In the event that the item 20 becomes lost, the reporting party 14 makes a visual inspection of the tag 12 to ascertain the reporting information (e.g., toll free telephone number) and the item registration number, which are both prominently displayed on the tag. This enables the reporting party 14 to initiate a lost item report using the information displayed on the tag 12, for example by using a telephone to call the toll free telephone number, which connects the reporting party with the Lost Item Response System 22 of the LIM system 16. At the onset of the telephone call, the Lost Item Response System obtains location information indicating a geographic location of the origin of the lost item report and prompts the reporting party to select a language for interacting with the system based on the geographic location information. Typically, the list of available languages will be tailored for a particular reporting party based on originating location information indicating the geographical location of the reporting party, such as the incoming telephone number (CLID), when available, and/or the identification of an originating base station, switch, inter-exchange carrier, or other information gathered by the Lost Item Response System at the time the call is connected. During the telephone call placing the lost item report, the Lost Item Response System 22 also receives the item registration number printed on the tag 12 and records the geographical location information and the language selected by the reporting party 14 for communicating with the LIM system. The Lost Item Response System also prompts the reporting party to provide return contact information and, optionally, to record a voice message, which the LIM system may translate if the subscriber and reporting party use different languages.

After the LIM system 16 has received the lost item report, it implements lost item notification in accordance with the contact profile created for the item at the time of item registration, which may have been updated from time to time by the subscriber, as needed. To facilitate recovery of the lost item, the LIM system 16 transmits one or more lost item notification messages in accordance with the contact profile for the item stored in the Lost Item Database 26. The lost item notification message includes at least the brief description of the item contained in the Lost Item Database 26, which was entered by the subscriber 18. This ensures that the lost item will be identified in a manner that the subscriber (including, for this purpose, all of the persons listed as contact persons in the item record for the lost item) will easily understand. The lost item notification message also includes an indication of the language used by the reporting party 14 when placing the lost item report, so that the subscriber can obtain the assistance of a person speaking that language, if necessary, when contacting the reporting party. The lost item notification message also includes the return contact information obtained in connection with the lost item report, and may also include the CLID if available, originating location information, possibly a voice message recorded by the reporting party, and any other information that the LIM system is programmed to record and provide to the subscriber. The subscriber can then use all of this information to validate the lost item report, determine whether item recovery is warranted in view of the particular item lost and other circumstances, and prepare to contact the reporting party if recovery is desired.

FIG. 1 also illustrates the provisioning and activation of countermeasures, which may be implemented on an item-by-item basis. Basically, the tag 12 and/or the item 20 can be configured with countermeasures that can be activated by the LIM system 16. The countermeasures can be activated automatically upon receipt of the lost item report, but typically will be password protected to give the subscriber 18 control over activation of the countermeasures. That is, after receiving an initial lost item notification message, the subscriber 18 will typically place a telephone call to the LIM system 16 to enter a password protected countermeasure activation command that activates the countermeasure selected by the registering party. For example, countermeasures may include activation of an RFID circuit provided as part of the lost item tag that responds to an electronic interrogation after activation to identify the item as a lost item. Other countermeasures may include an alarm, position indicating beacon, electronic lock, or any other suitable countermeasure provisioned into the tag or item and configured through the LIM system 16.

In view of the foregoing, it will be appreciated that the LIM system 16 provides for a lost item registration and management that can operate will little or no operator assistance other than maintenance and augmentation of the supporting systems as the number of subscribers and the size of the Lost Item Database 26 increases over time. Of course, a modest amount of operator assistance may be available, such as telephone or on-line support, as part of the basic subscription package. Additional human assistance may also be provided on a fee-for-service basis at any appropriate point in the item registration and recovery process. Although may additional features and options may be implemented, FIGS. 2-14 illustrate a specific implementation of the LINR 10 that is currently considered to be suitable of commercial deployment.

FIG. 2 is a conceptual illustration of a lost item management tag 12. As noted previously, the tag displays the lost item message 30 “To Report Lost Item CALL”; the reporting information 32 which, in this case, is the toll-free telephone number “888 252 7777”; and the item registration number 34 “ITEM: 12563 8529 4561.” The lost item message may be displayed in multiple languages, if desired, typically as requested by the subscriber at the time the tag is printed to ordered. Many different types of lost item management tags may be used, ranging from paper labels printed locally by the subscriber to metal engraved specialty tags suitable for permanent attachment to durable items, such as computers, firearms, luggage or cameras. Other examples of specialty tags include embroidered cloth tags that can be sewn into clothing, printed self-adhesive Mylar® or plastic tags suitable for attachment to computer equipment and paper items such as books, printed self-adhesive foil tags designed for permanent attachment to leather items such as wallets handbags, stamped metal hang tags designed for key rings and pet collars, and so forth. In general, the subscriber may print desired tags locally for no extra charge or purchase desired specialty tags through the tag ordering system 28.

A tag 12 ordered through the Tag Ordering System 28 may also include a built-in RFID tag 35 that can be programmed to communicate the data displayed on the tag when polled by an RFID reader. Also, the RFID tag 35 may remain dormant until it is activated by a predefined transmission, such as a digital paging message addressed to the RFID tag. For example, the tag may include a paging or telephone chip that can be accessed using the telephone system. In this manner, the RFID tag 35 can be activated to identify the associated items after it has been reported lost. The RFID tag 35 could also include a GPS location indicating device and a reporting beacon or telephone chip configured to report back the location of the tag in accordance with a programmed protocol. A combined telephone-GPS chip 37 could be deployed directly on the tag 12 for this purpose, if desired.

FIG. 3 is a conceptual illustration of the item registration number 34. In this example, the item registration number includes a 5-digit customer code 36, a 4-digit group code 38, and a four digit item code 40. The first digit of the group code may serve as a group identifier and the next three as a sub-group code, if desired. Although alpha-numeric digits may be used, numeric digits alone may be preferred to facilitate the use of a telephone keypad to enter a lost item report. The customer code 36 is intended to identify a subscriber that may include multiple individual users, such as a family, business or other association. Each individual is assigned a group code 38, who may each have an associated group of items registered as identified by associated item codes. Thus, the item registration number 34 will allow 100,000 customers, each having up to 10,000 groups, each having up to 10,000 registered items. The inclusion of an additional one or two-digit “series code” will allow the number of customers to be increased by a factor of 10 or 100, should that become necessary.

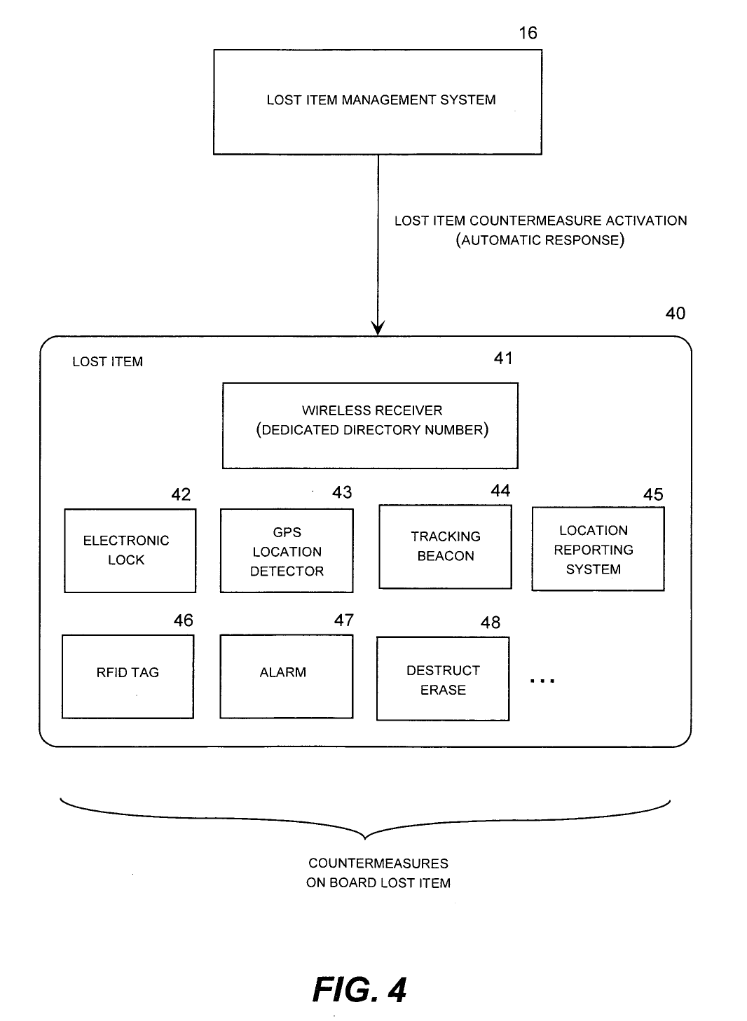

FIG. 4 is a functional block diagram of an item 40 configured to implement countermeasures upon receiving a lost item countermeasures activation communication message from the LIM system 16. The item 40 includes a communications device, such as wireless receiver 40 having an assigned directory number for accessing the item using a conventional telephone, paging or text message. This allows the LIM system 16 to remotely access the item 40 to implement any available the on-board countermeasures, such as electronic lock 42 that may be used to disable the item. The electronic lock 42 is considered to be appropriate for items such as firearms, other types of potentially dangerous items, and computers that may contain sensitive data. The item 40 may also include a GPS location detection device 43, a tracking beacon 44, and a location reporting system 45 that can be accessed or activated to determine and track the location of the item. Other countermeasures may include an RFID tag 46 internal to the item, an alarm 47, a system 48 that erases the data on a data storage device, and any other suitable type of countermeasure that the subscriber may provision. As noted previously, some of these countermeasures, such as the RFID tag and a telephone-GPS chip may be physically deployed as part of the lost item management tag, whereas others, such as the electronic lock or alarm, may be internal to the item 40. Countermeasures may also be deployed external to the item and associated tag, such as deactivating a lost credit or debit card, invalidating a lost passport, deactivating a telephone number, disabling a security device to recognize a lost access card, alerting proper authorities, and so forth.

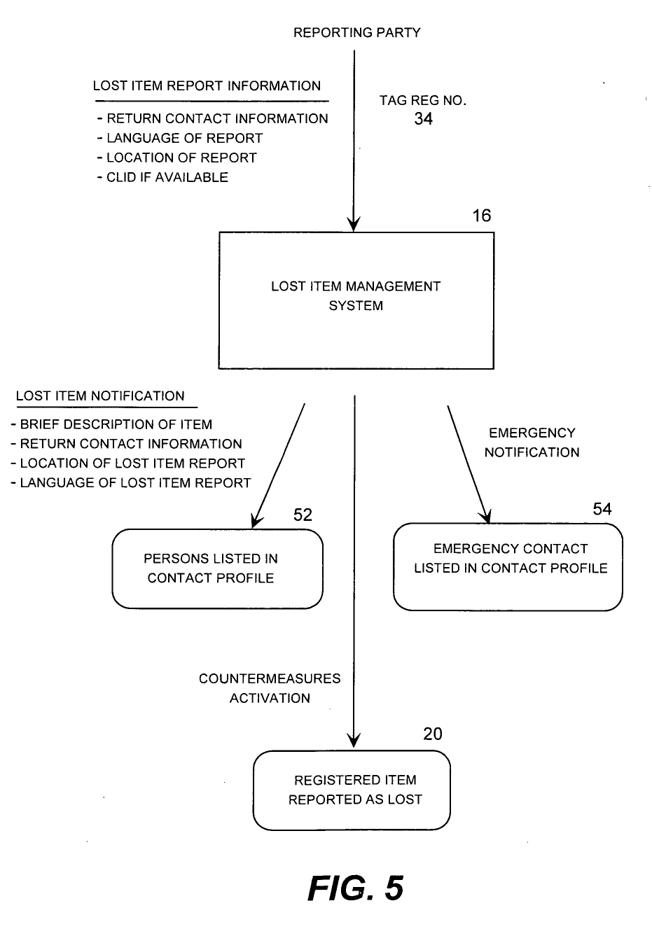

FIG. 5 is a functional block diagram of lost item reporting and notification in the LINR system 10. Generally, the reporting party 18 places a lost item report to the LIM system 16, which responds as programmed. This generally includes contacting the persons identified in the contact profile associated with the item, as stored in the Lost Item Database 26. The LIM system 16 may also implement countermeasures as indicated in the Lost Item Database, such as reporting the item lost an activating countermeasures located onboard the item, as described previously with reference to FIG. 4. In addition, the LIM system 16 may contact emergency personnel, when appropriate, as indicated in the Lost Item Database.

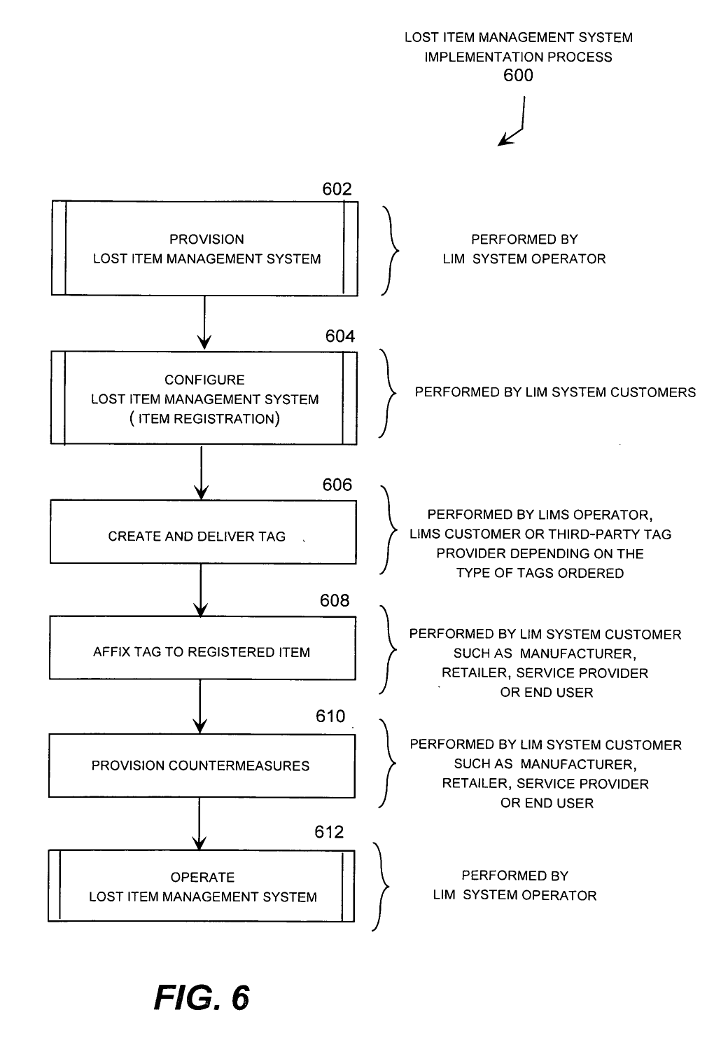

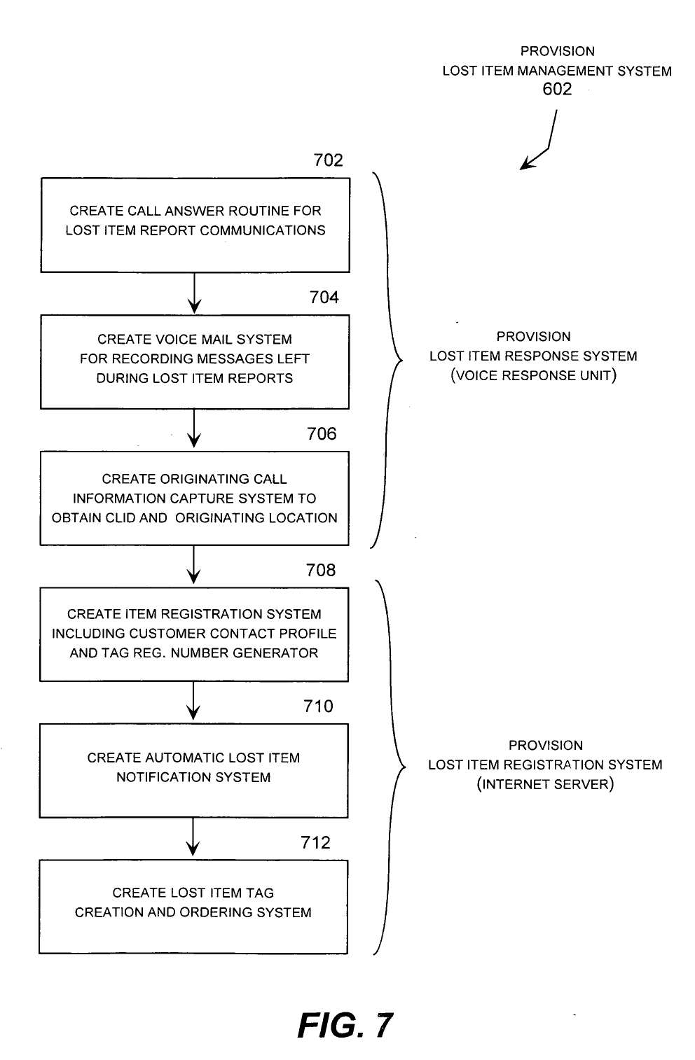

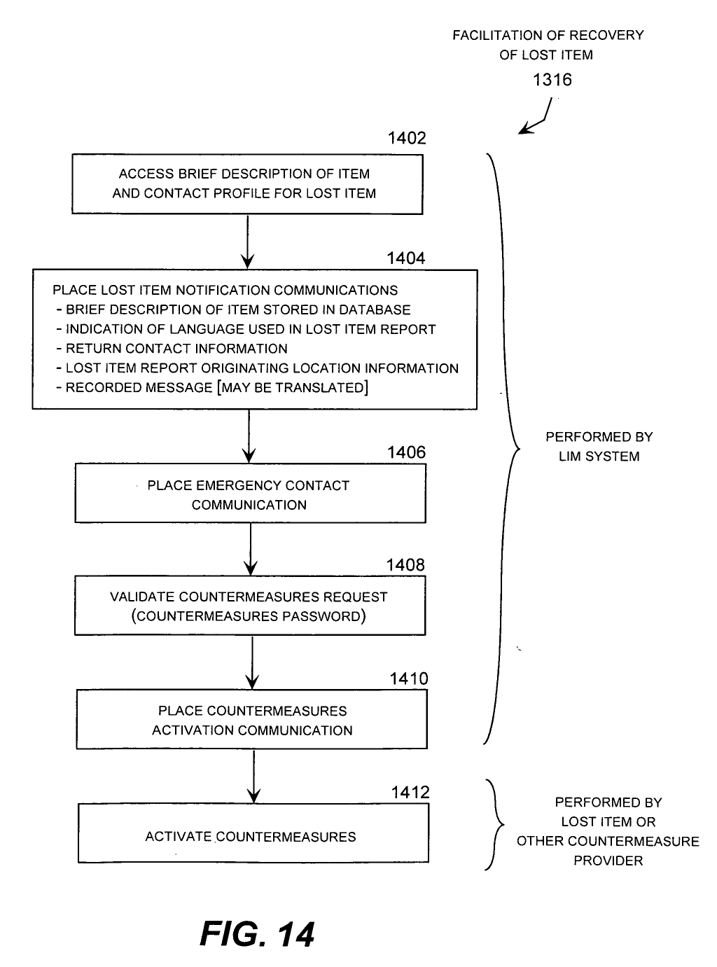

FIG. 6 is a logic flow diagram 600 illustrating a process for implementing an automated LIM system 16. In step 602, the operator or proprietor provisions the LIM system with appropriate functionality, as described in greater detail with reference to FIG. 7. Step 602 is followed by step 604, in which the individual subscribers configure the LIM system to register their particular items for lost item management, as described in greater detail with reference to FIGS. 8-13. Step 604 is followed by step 606, in which a subscribers obtains lost item management tags for the individual items to be tagged. This step may be performed the subscriber, by the Tag Ordering System 28, or by a third-party vendor, as selected by the subscriber. Step 606 is followed by step 608, in which the subscriber attaches the tag to its associated item. Step 608 is followed by step 610, in which the subscriber provisions countermeasures associated with the tagged item. Step 610 is followed by step 612, in which LIM system is operated, as described in greater detail with reference to FIG. 13-14.

FIG. 7 is a logic flow diagram illustrating step 602 for provisioning the LIM system 16. Although the steps of routine 602 are shown as sequential, they are provisioning steps that need not be implemented in any particular order. Referring to FIG. 1, steps 702-706 are associated with provisioning the Lost Item Response System 22, whereas steps 708-712 are associated with provisioning the Lost Item Registration and Notification System 24. In step 702, the system operator creates an appropriate call answering routine for Lost Item Response System. This should generally include the capture of origination location information regarding the lost item report, the selection of a desired language by the reporting party, followed by the receipt of the tag registration number and return contact information. Because the item description will be retrieved from the Lost Item Database 28, the reporting party may but need not be asked to describe the item. The reporting party will usually be asked to leave return contact information, which may be as simple as verifying that the CLID associated with the telephone used to make the call can be used to contact the reporting party. In most cases, the reporting party will also be invited to leave a message for the subscriber. Although the call answering routine may be as sophisticated as desired, the LIM system is designed to make the routine as simple a possible by eliminating the need for the reporting party to describe the item or, if CLID is available, enter return contact information. Minimizing the length and complexity of the lost item report is important to prevent the reporting party from becoming frustrated and hanging up before completing the process.

In step 704, the system operator creates a voice mail system for recording and playing back the voice messages left by the reporting parties. When there is a language difference between the reporting and the subscriber, this step may include translating the message left by the reporting party. A typed version of the message, particularly when translated into a different language, may be included in email lost item notification messages. In step 706, the system operator creates a data capture system to obtain and store location information associated with the lost item report. This typically includes at least the CLID, when available, of the originating telephone call. The LIM system may also be configured to obtain the originating base station, originating switch, inter-exchange carrier, or other information available through the telephone system at the time the call is connected or shortly thereafter. This information may be available through a Call Detail Record (CDR) or through an in-process CDR record or interface while the call is in progress. The LIM system may also access a home or visitor location register, local number portability database, signal control point, or other data facility to obtain location and ownership information associated with the telephone used to place the lost item report.

In step 708, the system operator creates an item registration system that can be accessed by subscribers to register their items for lost item management. An illustrative set of user interface panels for this purpose are shown in FIGS. 8-11. Of course, these illustrative user interface panels are simplified examples provided to illustrate the basic process, and it should be understood that a more sophisticated set of panels and associated functionality may be incorporated into commercial embodiments. In general, the item registration system should be user friendly and intuitively obvious so that the subscribers can register their items with little training or support. In step 710, the system operator configures the LIM system to implement automatic lost item notification messages in response to the lost item reports. This generally includes placing the lost item notification messages, emergency contact messages, and countermeasure activation messages in accordance with contact profiles entered by the subscriber. In step 712, the system operator configures the Tag Ordering System 28, which allows the user to print or order tags of various specifications.

FIG. 8 is a conceptual diagram of a customer and group registration panel for entering item registration information into the Lost Item Database 26. In this particular example, the subscriber enters a customer name “Acme Industries” and the LIM system assigns the subscriber a 5-digit customer number “12563.” The subscriber then sets up a number of groups, such as a group for each of a number of employees, and the LIM system assigns a 4-digit group number to each group. For example, “Al Smith” is assigned group number “8529”; “Jack Jackson” is assigned group number “8530” and so forth. In this manner, the LIM system ensures that each subscriber and group is assigned a unique identifier for use in the system.

FIG. 9 is a conceptual diagram of a contact profile entry panel for entering item contact profiles into the Lost Item Database 26. In this example, the subscriber creates a number of contact profiles labeled “Contact Profile—A”; “Contact Profile—B”; and so forth, so that particular contact profiles can be assigned to individual items, as desired. This allows the subscriber flexibility in defining and assigning contact profiles, which may be desirable for families, business and other associations. In general, each contact profile includes a primary telephone contact, a secondary telephone contact, a primary email contact, and secondary email contact, an emergency contact, and a password and address, such as a dedicated telephone number, that may be required to activate countermeasures. Of course, all but one of these items may be left blank and additional contacts may be defined, if desired. The LIM system may also be configured to notify all of the various contacts upon receipt of a lost item report, or in accordance with a hierarchical contact system.

It should be noted that the LIM system may also be useful for monitoring or providing useful indications regarding the location and status of pets, children and persons. For example, pets and children may carry tags similar to those carried by inanimate items to facilitate their recovery should they become lost. In addition, a number of items turning up lost for a person traveling abroad in a dangerous part of the world may indicate that something may have happened to that person. The loss of certain important items, such as a firearm, computer, passport, security access device, or the like may indicate the need to immediately alert certain emergency response personnel. For this reason, the LIM system may be configured to notify an emergency contact person whenever a particular item or set of items is reported lost.

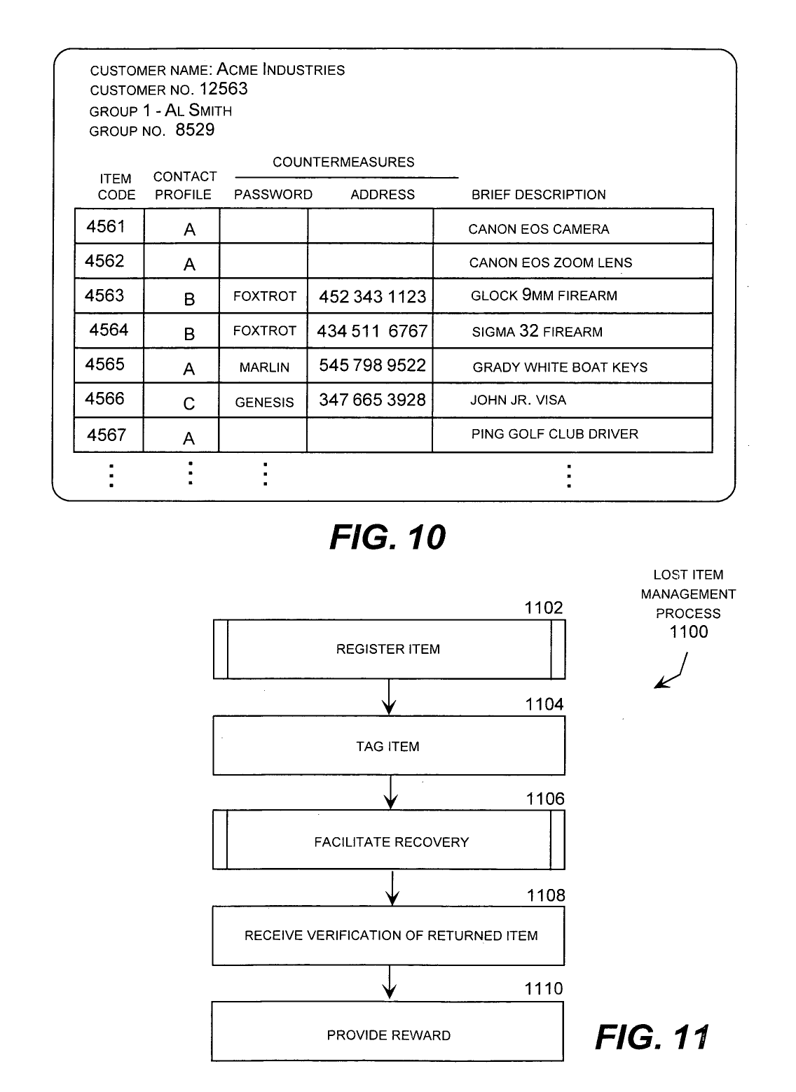

FIG. 10 is a conceptual diagram of an item registration profile entry panel for entering item registration information into the Lost Item Database 26. This particular panel shows group of items registered for Acme Industries (Customer No. 12563) and group 1, Al Smith (Group No. 8529). The panel shows item nos. 4561-4567 and the associated contact profiles and the brief descriptions of the items. Note that items 4563-4566 have countermeasure passwords and addresses listed. When a lost item report is received for a registered item, the LIM system sends a lost item notification message to each of the telephone and email contacts in the contact profile associated with the item. At noted previously, the lost item notification message includes the brief description of the item maintained tin the Lost Item Database 26, as shown in FIG. 10. This ensures that the lost item notification message includes a proper description of the registered item in a manner that will be easily understood the subscriber.

Item nos. 4563-4566 illustrate important items that have associated countermeasures, in this example a firearms, a boat, and a credit card. For these items, the subscriber may respond to the lost item notification message by accessing the LIM system and giving the appropriate item registration number and countermeasure activation password. This causes the LIM system to place a countermeasure activation message to the address for the associated item as recorded in the Lost Item Database 26. For example, the address may be a telephone directory number assigned to a telephone chip (or combined telephone-GPS chip) carried by the item. The countermeasure activation message may therefore contact the item directly to implement an associated countermeasure, such as electronically locking the firearm or disabling the ignition system of the boat. A similar countermeasure may be used for a computer or other electronic device. For the credit card, the countermeasure activation message placed to the countermeasure address external to the item itself to deactivate the credit card. Of course, these are merely a few illustrative countermeasures and many other countermeasures, such as GPS location tracking and reporting, alarm activation, security access device activation or deactivation, RFID device activation, and so forth, may be implemented as desired.

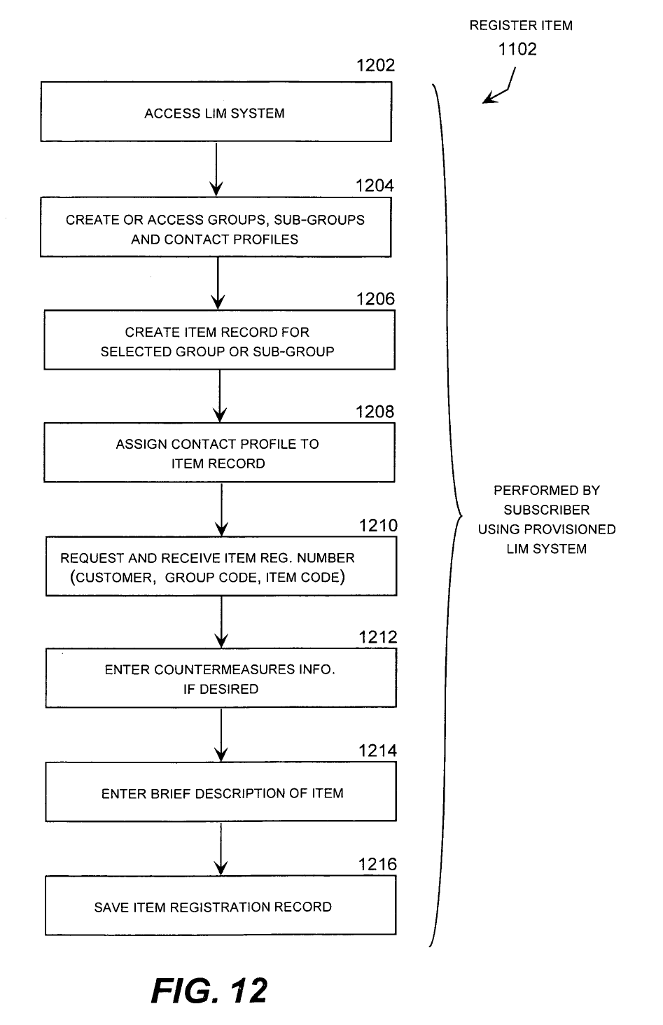

FIG. 11 is a logic flow diagram illustrating a lost item management process 1100. Once the LIM system has been provisioned as described with reference to FIG. 7, in step 1102 the subscriber access the LIM system to register items, as described above with reference to FIGS. 8-10 and in more detail below with reference to FIG. 12. In step 1104, the subscriber then prints or orders lost item management tags using the Tag Ordering System 28 and affixes the tags to the associated items. In step 1106, the LIM system facilitates recovery of the lost item, as described in more detail below with reference to FIGS. 13 and 14. If the item is successfully recovered, in step 1108 the LIM system may receive verification of the successful recovery and, in step 1110, provide a reward to the reporting party or others. For example, the reporting party may receive a free subscription to the LIM system and/or a monetary reward based in part on the value of the item returned. In particular, cash incentives may be appropriate for expensive, potentially dangerous or sensitive items such as wallets, firearms and computers, whereas a free subscription may be appropriate for cameras, golf club and items of clothing. The operator of LIM system and third parties, such as private investigators assisting in the recovery process, may also receive compensation on the basis of the value or importance of items successfully recovered. Again, these are a few illustrative examples of potential rewards for reporting parties, and more sophisticated reward systems may be implemented as desired.

FIG. 12 is a logic flow diagram expanding on step 1102 shown on FIG. 11 for an item registration process, which is typically used to configure the Lost Item Database 26 shown on FIG. 1. Note that at this point, the Lost Item Database has already been previously provisioned with appropriate user interfaces, databases facilities, and other functionality as described with reference to FIG. 7, and is therefore ready to be configured with user-supplied data with little or no assistance from a live operator. In step 1202, the subscriber access the LIM system, typically over the Internet. This step will usually require entry of a password for a previously created account or the creation of a new account and password. Step 1202 is followed by step 1204, in which the subscriber creates or accesses groups, sub-groups and contact profiles using user interface panels such as those shown in FIGS. 8-9. Although FIG. 8 does not show sub-groups, the LIM system may be configured to allow the subscriber to create sub-groups or any other suitable categories or hierarchies for organizing items for lost item management. In particular, a sub-groups could be created for all items in a particular group having common contact profile, or all items in a particular group having countermeasures, or all items having some other characteristic creating a logical association among the items in the sub-group.

Step 1204 is followed by step 1206, in which the subscriber creates item records for selected groups or sub-groups using a user interface panel such as the panel shown in FIG. 10. In particular, the subscriber enters a short description of the item into the Lost Item Database 26, which is supplied back to the subscriber, typically with a computer generated voice for telephone contact or in text for an email contact, in any lost item notification message relating to the item. Step 1206 is followed by step 1208, in which the subscriber associates a contact profile with an item record. Step 1208 is followed by step 1210, in which the subscriber requests and receives an item registration number for the item, which typically includes a customer code, group code (which may incorporate a group identifier and sub-group code), and an item code. An example of the a suitable item registration number is shown in FIG. 3. The LIM system typically generates the numerical codes that serve as the customer codes, group codes, and item codes to ensure that each item registration number assigned by the LIM system is unique. Step 1210 is followed by step 1212, in which the subscriber enters countermeasure information, such as an address and password, if desired. Step 1210 is followed by step 1212, in which the subscriber enters a brief description of the item, and step 1212 is followed by step 1214, in which the subscriber saves the item record. This process can be repeated to create as many groups, sub-groups and item records as the subscriber desires.

As a result, each item record identifies a customer code, a group code, which am possibly include a group identifier and a sub-group code, a specific item code, a brief description of the item, a contact profile for the lost item notification message, and a countermeasures address and password, if desired. It will be appreciated that the level of contact and countermeasure sophistication shown in FIGS. 8-10 is powerful yet relatively simple and easy to understand and implement. Of course, additional functionality and sophistication, such as hierarchical and interactive contact and countermeasure paradigms, may be configured into the LIM system. The basic functionality shown in FIGS. 8-10 may be appropriate as standard system functionality, whereas user-specific customization and system development may be offered on a consulting basis for those customers desiring additional functionality and services. In this manner, the LIM system may be adapted for use by subscribers ranging from individuals, to families and small businesses with a small number of groups with modest budgets and relatively simple requirements, to large groups such as major corporations and governmental organizations with a large number of groups, substantial system development budgets, and complex and changing requirement and objectives.

FIG. 13 is a logic flow diagram expanding on step 1106 shown on FIG. 11 for facilitating lost item recovery. Steps 1302-1314 are typically performed by the VRU associated with the Lost Item Response System 22 during a lost item report communicated by a reporting party who has found a lost item, whereas step 1316 (expanded in FIG. 14) is typically performed by the computer platform associated with the Lost Item Registration and Notification System 28 after receipt of the lost item report. In step 1302, the LIM system receives a lost item report communication, typically a telephone call placed to a dedicated telephone number displayed on a lost item management tag, from a reporting party who has found a lost item with a list item management tag associated with the LIM system. Step 1302 is a followed by step 1304, in which the LIM system captures the CLID of the telephone used to place the lost item report (i.e., the director number of the telephone used to place the lost item report provided through the caller-ID or CLID feature), if available (the CLID feature can be blocked).

Step 1304 is a followed by step 1306, in which the LIM system obtains originating location information associated with the lost item report communication. For example, the originating location information may be obtained from a look-up table based on the directory number of the telephone placing the lost item report communication, an originating base station antenna where the communication was initially received, a originating telephone switch carrying the communication, and inter-exchange carrier transmitting the communication, or any other available information regarding the lost item report communication. This information may be available through the SS7 signaling system, an overhead data channel, a call detail record, an in-process call-detail record (CDR) or interface, a signal control point (SCP), a home or visitor location register (HLR or VLR), a local number portability (LNP) database, or any other available resource in the interconnected telephone system.

Step 1306 is a followed by step 1308, in which the LIM system prompts the reporting party to select a language for communicating with the system. The LIM system preferably selects an appropriate list of languages organized in a priority order based on the originating location information captured at the time the lost item report communication was connected to the LIM system VRU platform. This allows reporting parties all around the world, regardless of the language spoken, to call the directory number displayed the lost item management tag and interact with the LIM system using a familiar language. This is a key feature of the LIM system, which allows the deployment of a world-wide LIM system that is capable of handling lost item reports for items that may be lost while subscribers are traveling abroad.

Step 1308 is a followed by step 1310, in which the LIM system prompts the reporting party to enter the tag registration number displayed on the lost item management tag. The tag registration number is preferably numeric to make entry of the number easy using a conventional telephone keypad so that this minimal amount of data that can be easily and quickly entered with the telephone keypad. Step 1310 is a followed by step 1312, in which the LIM system prompts the reporting party to provide return contact information. If the CLID is available, this may be a simple as confirming that a return telephone call may be placed the CLID. In this case, no further data entry is required of the reporting party. If the CLID is not available, the reporting party may be prompted to enter a return telephone number using the telephone keypad. In most cases, the reporting party will also be invited to record a message, which the LIM system records, and may translate, for subsequent replay and/or text publication to the subscriber. Step 1312 is a followed by step 1314, in which the LIM system may provide the reporting party with information relating to a reward that may be provided to the reporting party if the lost item is successfully returned. Step 1314 is a followed by step 1316, in which the LIM system facilitates recovery of the lost item, as described in more detail with reference to FIG. 14.

FIG. 14 is a logic flow diagram expanding step 1316 shown in FIG. 13 for facilitating recovery of the lost item. Steps 1402-1410 are typically performed by the LIM system, whereas step 1412 refers to countermeasures that may be performed by the lost item or another countermeasure provider, for example a credit card company that cancels a credit card upon receipt of notification that the card has become lost. In step 1402, the LIM system accesses the Lost Item Database 26 and looks up the item record for the item that has been reported lost. Step 1402 is a followed by step 1404, in which the LIM system places lost item notifications in accordance with the contact profile identified in the item record for the lost item. The lost item notification message includes at least the brief description of the item stored in the item record contained in the Lost Item Database 26, an indication of the language selected by the reporting party when placing the lost item report, and the return contact information obtained during the lost item report. The lost item notification message may also include an indication of the geographic location where the lost item report originated, as captured by the LIM system during or following the lost item report. The lost item notification message may further include a voice or text message recorded during the lost item report, which may be translated if the subscriber and reporting party use different languages.

Step 1404 is a followed by step 1406, in which the LIM system places emergency contact communications in accordance with the contact profile identified in the item record for the lost item. This is an optional feature that may be appropriate for lost item management tags assigned to pets, persons, or items of particular importance, such as a person's passport, firearm, computer, or the like. Step 1406 is a followed by step 1408, in which the LIM system may receive a countermeasure activation message, typically from the subscriber or another authorized person, communicating a particular lost item and the associated countermeasure password. In this case, step 1408 is a followed by step 1410, in which the LIM system places countermeasure activation messages in accordance with applicable item record. step 1410 is then a followed by step 1412, in which the countermeasures are activated, as described in more detail with reverence to FIG. 4. If desired, the LIM system may be configured to omit step 1408 and implement the countermeasures defined for an item immediately upon receipt of a lost item report. The LIM system may also implement additional interactive countermeasure functionality, for example to turn off countermeasures or implement staged countermeasures, if desired.

Following the successful recovery of the lost item, the LIM system or a human operator may receive notification of the successful return of the lost item and provide the reporting party with an appropriate reward. Other parties, such as the LIM system operator or private investigators involved in the recovery process, may also receive compensation based on the successful return of the lost item and the value or importance of the lost item. The reward parameters for a particular item may be defined in advance and stored in the item record for the item. This allows the LIM system to accurately communicate the applicable reward to the reporting party during the lost item report communication. Many other features of the lost item notification and recovery system will become apparent to those skilled in the art once the principles of the invention, as described above, are understood.

In view of the foregoing, it will be appreciated that present invention provides significant improvements in lost item management systems. It should be understood that the foregoing relates only to the exemplary embodiments of the present invention, and that numerous changes may be made therein without departing from the spirit and scope of the invention as defined by the following claims.

The invention claimed is:

1. A method for managing items, comprising the steps of:
registering an item for lost item management by receiving a brief description of the item, receiving contact information associated with the item, assigning a registration number to the item, and storing the brief description of the item, the contact information associated with the item, and the item registration number in a computer file;
tagging the item for lost item management by rendering a tag displaying a lost item message, reporting information, and the item registration number and affixing the tag to the item; and
facilitating return of the item when it becomes lost by:
receiving a lost item report from a reporting party in accordance with the reporting information contained on the tag indicating that the item has become lost;
ascertaining return communication information associated with the reporting party,
retrieving the brief description of an item from the computer file,
delivering a lost item notification message in accordance with the contact information contained in the computer file, and
wherein the lost item notification message comprises the brief description of the item retrieved from the computer file and the return communication information associated with the reporting party.

2. The method of claim 1, further comprising the steps of receiving a caller identification information associated with the lost item report indicating an originating directory number assigned to a communications device used to originate the lost item report and including the originating directory number in the lost item notification message.

3. The method of claim 1, further comprising the steps of:
prompting the reporting party to record a voice message with return contact information;
recording the voice message; and
playing the voice message in connection with the lost item notification message.

4. The method of claim 1, further comprising the steps of ascertaining that the lost item has been returned and providing a reward to the reporting party.

5. The computer-controlled apparatus of claim 1, further configured to automatically implement the steps of registering an item for lost item management and facilitating return of the item upon becoming lost without intervention by a human operator.

6. A computer-controlled apparatus configured to implement the method of claim 1.

7. An computer storage medium storing computer executable instructions for implementing the method of claim 1.

8. A method for managing items, comprising the steps of:
registering an item for lost item management by receiving contact information associated with the item, assigning a registration number to the item, and storing the contact information associated with the item and the item registration number in a computer file;
tagging the item for lost item management by rendering a tag displaying a lost item message, reporting information, and the item registration number and affixing the tag to the item; and
facilitating return of the item when it becomes lost by:
receiving a lost item report from a reporting party in accordance with the reporting information contained on the tag indicating that the item has become lost,
ascertaining return communication information associated with the reporting party,
ascertaining a reporting language used by the reporting party when communicating the lost item report,
delivering a lost item notification message in accordance with the contact information contained in the computer file, and
wherein the lost item notification message comprises an indication of the reporting language and the return communication information associated with the reporting party.

9. A computer-controlled apparatus configured to implement the method of claim 8.

10. An computer storage medium storing computer executable instructions for implementing the method of claim 8.

11. A method for managing items, comprising the steps of:
registering an item for lost item management by receiving contact information associated with the item, assigning a registration number to the item, and storing the contact information associated with the item and the item registration number in a computer file;
tagging the item for lost item management by rendering a tag displaying a lost item message, reporting information, and the item registration number and affixing the tag to the item; and
facilitating return of the item when it becomes lost by:
receiving a lost item report from a reporting party in accordance with the reporting information contained on the tag indicating that the item has become lost,
ascertaining return communication information associated with the reporting party,
ascertaining reporting location information from communication routing information associated with the lost item report,
delivering a lost item notification message in accordance with the contact information contained in the computer file, and
wherein the lost item notification message comprises an indication of the reporting location information and the return communication information associated with the reporting party.

12. The method of claim 11, wherein the location information is selected from the group consisting of a mobile telephone base station, telephone switch, telephone carrier, or inter-exchange device associated with the lost item report.

13. A computer-controlled apparatus configured to implement the method of claim 11.

14. An computer storage medium storing computer executable instructions for implementing the method of claim 11.

15. A method for managing items, comprising the steps of:
registering an item for lost item management by receiving contact information associated with the item including a countermeasures address associated with a countermeasures communication device carried with the item, assigning a registration number to the item, and storing the contact information associated with the item and the item registration number in a computer file;
identifying the item for lost item management by rendering a tag displaying a lost item message, reporting information, and the item registration number and affixing the tag to the item;
facilitating return of the item when it becomes lost by receiving a lost item report from a reporting party in accordance with the reporting information contained on the tag indicating that the item has become lost, ascertaining return communication information associated with the reporting party, and delivering a lost item notification message in accordance with the contact information contained in the computer file; and
sending a countermeasures activation message to the countermeasures address in response to receiving the lost item report, wherein the countermeasures activation message is operational for activating a countermeasure affecting the lost item.

16. The method of claim 15, further comprising the steps of receiving and validating a countermeasures password in connection with the lost item report as a condition to sending the countermeasures activation message.

17. The method of claim 15, wherein the countermeasure comprises an electronic lock carried by the item disabling operation of the lost item.

18. The method of claim 15, wherein the countermeasure comprises a tracking device carried by the item configured to transmits location identifying information from the item.

19. The method of claim 15, wherein the countermeasure comprises an alarm carried by the item.

20. The method of claim 15, wherein the countermeasure comprises an RFID device associated with the tag attached to the item.
